(19) United States
(12) Patent Application Publication
(10) Pub. No.: US 2005/0261120 A1
(43) Pub. Date: Nov. 24, 2005

(54) Structure and construction method to form smooth hydrophilic surface

(76) Inventor: Lin Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/851,128

(22) Filed: May 24, 2004

(51) Int. Cl. C04B 35/00; C03C 10/00

(52) U.S. Cl. 501/1; 501/2; 15/103.5

(57) ABSTRACT

An improved structure and construction method to form a smooth hydrophilic surface are described. A layer of a photo-catalyst, Titanium Dioxide (TiO2), is mopped on the smooth surface to achieve self and convenient clearance abilities, which can be widely used on/with interior decoration and building structure. The photo-TiO2-catalyst solution is mopped on the smooth surface with the absorbent material. The invention is self-clearing and convenient, maintains a clean surface, economizes manpower and is effectively used.

### FIELD OF THE INVENTION

The present invention relates to the structure and construction method of a smooth hydrophilic surface by mopping a layer of photo-TiO2-catalyst on a smooth surface such as glass or the like to achieve self and convenient clearance. The present invention can be used on/with a hydrophilic environment such as interior decoration and building surface. The aqueous photo-TiO2-catalyst solution coordinated with suitable absorption material then is mopped on the smooth surface.

### BACKGROUND OF THE INVENTION

TiO2 is authorized by American PDA center and is widely known by the public as a safe material that has been used in the food industries, daily products, cosmetics, pharmaceuticals and aquaculture. TiO2 generates a free-radical hydroxide under photo-catalysis and reacts with organic substances to form non-toxic product in a free-air environment. Free-radical hydroxide generated from TiO2 destroys the energy factor of organic gas to form a single gaseous molecule, which expresses the decomposition progress of organic materials and gaseousness, and raises deodorization abilities. The photo-TiO2-catalyst has a better oxidation capacity than ozone or anions. Authentic Western Lab testing shows photo-catalysis is 150 times higher in its deodorization capability than high-performance activated carbon fiber per centimeter, which is nearly 500 pieces of deodorizer using activated carbon fiber in a refrigerator. On the other hand, the photo-catalyst is a non-re-pollution product. Specially treated, TiO2 is spatter-plated on glass, making the glass highly hydrophilic. The effect is that the glass increasing thermo stability up to 400 degrees centigrade and is antifogging and free of watermarks. Dust on the glass is then washable (self-clearance) under the gravitation and the hydrophilic function.

Nearly 40 years after the publication of the photo-catalysis theory in Nature (1972), TiO2 has only been studied in the recent two decades with the intention of environmental protection against pollution. The photo-TiO2-catalyst had an even wider usage when the superior hydrophilic ability thereof was discovered 15 years ago. Previously, the photo-TiO2-catalyst only worked under ultraviolet light; nowadays, practical TiO2 products working under visible light have come into the market in succession.

TiO2 is after aluminum (Al), Iron (Fe) and Titanium (Ti) in the list of metal elements. The global resources of TiO2 are listed in the 4^{th} position and the oxide form appears worldwide with stores of up to hundred million tons. Titanium oxide (TiO2) is an oxide products as well as a catalyst that is an N-semiconductor; in nature, TiO2 appears AS Anatases titanium dioxide (A-type TiO2), Rutile titanium dioxide(R-type TiO2) and Brookite (B-type). And A-type and B-type are, both individually and in a mixture, the most widely used as an industrial color- titanium white power, a food additive (certificated by American FDA food examination center), and as a functional textile product. Titanium white with TiO2 as the basic white color is used in painting, printing ink and pharmaceuticals. Titanium yellow is used in painting, printing ink and cement. TiO2 also has been widely used in the cosmetics and food industries. The yearly consumption of TiO2 product is over 3 million tons and the usage of TiO2 represents the national standard. On the other hand, photo-TiO2-catalyst has different natural properties whiling compared with standard coloring TiO2. During usage, its internal and external properties are better treated or considered separately. The semiconductor industry uses the light-sensitive property of TiO2; on the other hand, in the cosmetic market, titanium white is used for its dull-catalyst property where TiO2 serves as an ultraviolet absorber. One of the traditional photo-catalyst manufacturing methods is to form a self-clearing hydrophilic glass, and the vacuum splatter-plating method is shown in FIG. 1 for reference. FIG. 1 shows a diagrammatic sketch of the vacuum splatter-plating method. Kinetic energy-electron 12 bombard out an electron flow 14. The electron flow 14 contains Ti atom from target material 18 (which can contain a Ti atom). Electron flow 14 contains Ti atoms is driven by a certain voltage and plated on glass material 16 to form a thin TiO2 film. However, the mass production requires an express method to replace these current methods, which consist of expensive equipment, high maintenance costs, quite inconvenient methods, huge energy consumption when producing self-clearing hydrophilic glasses.

One of the traditional photo-catalyst manufacturing methods to form self-clearing hydrophilic glass, the solution infusion method, is shown in FIG. 2 for reference. FIG. 2 shows a diagrammatic sketch of the solution infusion method. This structure has a gripper 28 with a vertical motivation function that grips a glass plate 26 and is immersed vertically in TiO2 solution in solution groove 24. Glass plate 26 is then vertically pulled out of said solution groove 24 and dried to leave a thin TiO2 film on the treated surface. However, the force of gravity disturbs the smooth surface during the pulling out procedure, especially making the surface on the glass edges too thick. The low hydrophilic quality of these sections disables the final output, which leads to massive waste; therefore, a convenient mass production method is required to replace the current methods for producing self-clearing hydrophilic products.

The present invention provides convenient structure and low cost construction method for mass production. The present invention inherits traditional advantages of powerful self-clearing and disinfection abilities when forming smooth thin TiO2 film surfaces.

### SUMMARY OF THE INVENTION

The major purpose of present invention is to provide a structure and construction method for cheap, high quality mass production of smooth hydrophilic surfaces use on glasses, bathrooms, industrial decorations, commercial decorations, interior decorations and external surfaces of buildings.

To achieve the above purpose, the core structure of present invention is still the traditional hydrophilic self-clearing structure of TiO2, which copes with the new thin-film construction method to develop a convenient method and a smooth hydrophilic surface.

The method according to the present invention is described as follows. Prepare hydrophilic solvent solution. The hydrophilic solvent solution is absorbed by an absorbent material to and below the preserved volumetric ratio. The hydrophilic solvent solution is applied through the absorbent material on a smooth surface. Finally, the treated surface is dried to form the hydrophilic thin-film.

The construction method of the present invention forms a smooth hydrophilic surface, which consists of a substrate material with a smooth surface 36 and a hydrophilic thin-film on the smooth surface. The hydrophilic thin-film is photo-catalytic thin TiO2 film. The thin-film is 5 nm to 40 μm thick.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of the conventional manufacturing method of hydrophilic glass;

FIG. 2 is a schematic diagram of another conventional manufacturing method of hydrophilic glass; and

FIG. 3 is a schematic diagram of the present invention.

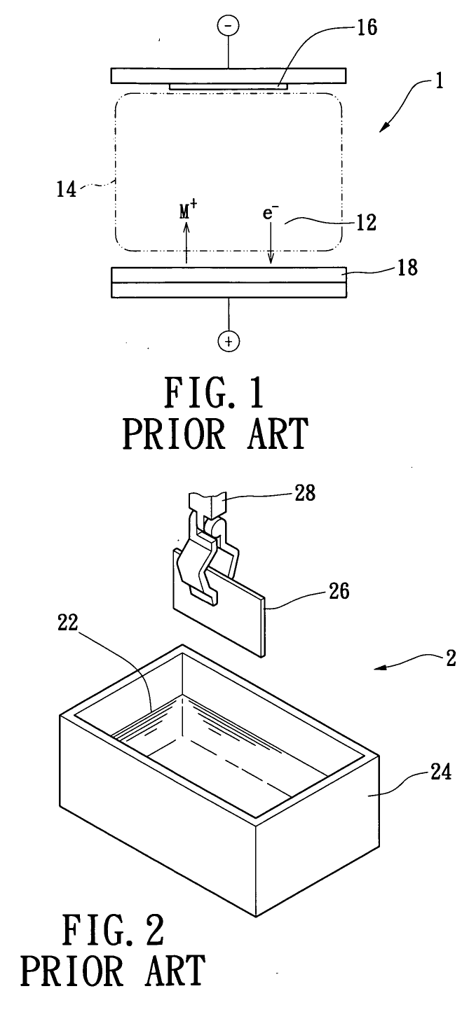

### DESCRIPTION OF THE PREFERRED EMBODIMENT

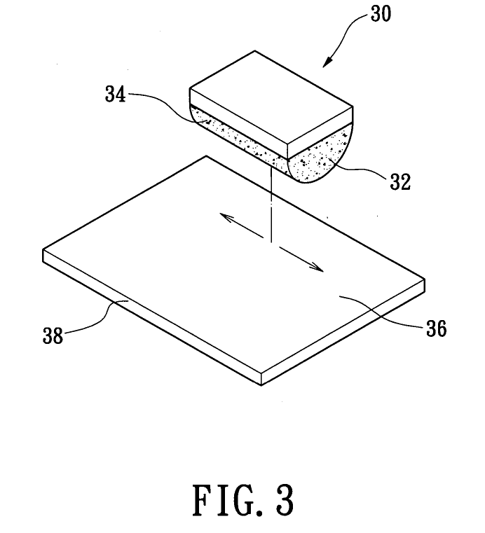

FIG. 3 is a schematic diagram of the implementation method according to the present invention. The cleaner 30 consists of an absorbent material 32 and a fasten section of the absorbent material 32. The absorbent material 32 absorbs said hydrophilic solution 34. The absorbance is lower than saturation to achieve better hydrophilic effect. The cleaner 30 mops the hydrophilic material on the smooth surface 36 (which can be the smooth surface of glass) of the substrate 38. The treated surface is then dried to form said hydrophilic thin-film. Drying time is 15 seconds or less since said smooth surface 36 is mopped by unsaturated absorbent material 32. The optimal hydrophilic solution to implement the present invention is photo-TiO2-catalyst with 100 nm to 10 nm thin TiO2 film.

As shown in FIG. 3, the implementation steps of present invention include: (1) Prepare preserved concentrated hydrophilic solvent solution 34. (2) Absorb the hydrophilic solvent solution 34 by said absorbent material 32 to or below a preserved volumetric ratio. (3) Mop the smooth surface 36 with the hydrophilic solvent solution 34 with said absorbent material 32; (4) dry the said smooth surface to form a thin-film layer on the smooth hydrophilic surface.

An implementation method refers to the hydrophilic solvent solution 34 as photo-TiO2-catalyst; for better decomposition effectiveness of TiO2, the scale of preserved concentrative solution is set below 10%, and preferably below 1%; for better hydrophilic effectiveness of the hydrophilic layer, the thickness is set between 5 nm to 40 μm. Before mopping with the absorbent material 32, a future decomposition of step 3 is to dry said absorbent material 32 to a preserved concentrative ratio to below 10%. This guarantees that the thickness of the thin-film is uniform to gain a better hydrophilic effectiveness. The smooth surface 36 can be a ceramic, glass or similar surface; however, a rough surface restricts self-clearing and hydrophilic abilities. The absorbent material for the hydrophilic solvent solution can be dust-free paper to stop the influence of dust or fiber on the effectiveness of the hydrophilic abilities thereof and the formation of the thin-film. The additive acetone and polyethylene into said hydrophilic solvent solution 34 are supplements to the resolution. A convenient mopping action taken in step 3 performed by the absorbent material 32 on said smooth surface 36 of the present invention can be manual, semi-automatic or fully automatic. The solvent of present invention is said to be water.

Structure of smooth hydrophilic surface of present invention is constructed by the previous method. The structure includes a substrate with a smooth surface 36 and a hydrophilic thin-film covering the smooth surface. The hydrophilic thin-film is a photo-catalyst thin-film, and the thickness of the hydrophilic thin TiO2 film is 5 nm to 40 μm

Above are described the optimal implementation of present invention; it will be apparent that various changes and modifications can be made without departing from the scope of the invention as defined in the claims.

1. A structure and construction method to form a smooth hydrophilic surface, comprising:
a) Prepare preserved concentrated hydrophilic solvent solution.
b) Absorb the said hydrophilic solvent solution with absorbent material to or below a preserved volumetric ratio.
c) Mop the said smooth surface with said absorbent material containing absorbed hydrophilic solvent solution.
d) Dry the said smooth surface to form a thin-film on the smooth surface, thereby forming the smooth hydrophilic surface.

2. The structure and construction method to form a smooth hydrophilic surface according to claim 1, wherein the ratio of preserved volumetric concentration in absorbed material is below about 30%.

3. The structure and construction method to form a smooth hydrophilic surface according to claim 1, wherein the hydrophilic solvent solution is a TiO2 photo-catalyst solution.

4. The structure and construction method to form a smooth hydrophilic surface according to claim 3, wherein a ratio between the preserved volumetric concentration of the TiO2 and a weight is below about 10%.

5. The structure and construction method to form a smooth hydrophilic surface according to claim 3, wherein a thickness of said hydrophilic thin-film is between 5 nm to 40 μm.

6. The structure and construction method to form a smooth hydrophilic surface according to claim 3, wherein a decomposition step before step 3 is to dry the absorbent material containing hydrophilic solvent solution to a preserved volumetric concentrative ratio below about 10%.

7. The structure and construction method to form a smooth hydrophilic surface according to claim 3, wherein the smooth surface is a ceramic surface or a glass surface.

8. The structure and construction method to form a smooth hydrophilic surface according to claim 3, wherein the absorbent material of said hydrophilic solvent solution is dust-free paper.

9. The structure and construction method to form a smooth hydrophilic surface according to claim 3, wherein said hydrophilic solvent solution has additive acetone and polyethylene.

10. The structure and construction method to form a smooth hydrophilic surface according to claim 3, wherein mopping in step 3 is manual, semi-automatic or fully automatic.

11. A structure of a smooth hydrophilic surface constructed according to claim 1, comprising:
a) A substrate material with a smooth surface.
b) The thin-film of the hydrophilic is on the top of said smooth surface.
c) A material of the thin-film of said hydrophilic surface is TiO2 photo-catalyst.
d) A thickness of the thin-film of said hydrophilic surface is about 5 nm to 40 μm.
